(19) United States
(12) Patent Application Publication
(10) Pub. No.: US 2009/0055278 A1
(43) Pub. Date: Feb. 26, 2009

(54) Complete Secure Retail Transaction Via A Mobile Device

(75) Inventor: Venkat Nemani, Bangalore (IN)

Correspondence Address: Saul Ewing LLP (Philadelphia), Attn: Patent Docket Clerk, 2 North Second St., Harrisburg, PA, 17101, US

(73) Assignee: SYMBIAN SOFTWARE LTD., London (GB)

(21) Appl. No.: 11/841,324

(22) Filed: Aug. 20, 2007

(51) Int. Cl. G06Q 30/00

(52) U.S. Cl. 705/17; 235/383; 455/414.1; 705/23

(57) ABSTRACT

The present invention incorporates scanning technology and secure payment technology into the operating system (OS) of a mobile device such as a smartphone. In a preferred embodiment, the scanning technology comprises RFID interrogation capability. This enables smartphone users to validate transactions during a shopping session at a retail location (i.e., scan items as they are added to their shopping cart) and streamline the payment process by electronically transmitting their credit/debit card information directly to their financial institution to authorize payment to finish the transaction, all while within the retail location.

### FIELD OF THE INVENTION

This invention relates to the field of transaction validation and payment methods and, more particularly, to transaction validation and payment methods utilizing mobile wireless devices such as mobile telephones.

### BACKGROUND OF THE INVENTION

Bar-code scanners and bar-code scanning technology have been in existence for many years, and scanning technology useable by consumers is finding its way into the retail marketplace. Many supermarkets and other retail stores have self-checkout areas where the consumer brings items to be purchased and which allow the consumer to total up the cost of their purchases and pay for them at a single station, with little or no help from store personnel. More recently, the Waitrose supermarket chain in the United Kingdom provided a service called “Quick Check” which allows consumers to scan items as they shop, using a handheld scanner provided by the supermarket. When finished shopping, the consumer goes to a POS terminal and pays for the already-scanned items using cash, debit card, or credit card.

While the above-described retail systems have clear benefits, they are certain aspects of them that are sub-optimal. For example, the supermarket must install scanning stations or supply the hand-held scanners for use by the consumer. Further, the consumers must still queue up to pay for the items they are purchasing, and to pay the user must directly interact with the retailer (either directly with human assistance or indirectly with retailer-provided payment processing systems). In addition to increasing overhead costs due to the expense of the payment processing systems, the security of the transaction is reduced, as the consumer must give confidential payment information (credit card numbers, debit card numbers, bank account numbers, etc.) to the retailer to complete the transaction. This can lead to identity theft and fraudulent credit card practices such as “skimming”.

Radio Frequency Identification (RFID) scanning technology is another form of scanning technology that is becoming more prevalent, particularly with the rapidly decreasing cost of RFID tags. The most common uses of RFID tags/RFID readers is in inventory control, product tracking, libraries, file-tracking, and automatic toll collection. Many of these applications use passive RFID tags applied to the product or item and then RFID readers are used to “interrogate” and extract information from the RFID tags when the RFID reader is placed in close proximity to the passive RFID tag.

The convergence of communications and computing is delivering a new generation of wireless information devices, often referred to as smart phones or communicators. The most capable of these devices utilize operating systems and related applications such as the Symbian platform from Symbian Limited of the United Kingdom. Wireless information devices based on the Symbian platform, are ‘smarter’ than current generation GSM phones in being able to offer multiple, advanced, robust client based applications. For example, current designs of communicators based on the Symbian platform include all of the applications found on a fully featured PDA, such as a contacts manager, messaging application, word processor, spreadsheet, synchronization etc.

With the emergence of these “smarter smart phones” such as the Symbian communicators described above have come numerous new uses for communicators not previously contemplated. Communicators can be programmed as bar code scanners to enable the scanning and processing of items bearing bar codes, and Nokia has recently incorporated RFID-reading capability into certain mobile devices.

Mobile phones are also being used as a means for paying for train fares, parking, and other similar transactions requiring the transfer of funds in return for products or services. Examples of such systems include Mobile Suica, a service for Osaifu Keitai mobile phones in Japan allowing for the purchase of fares on the Japanese JR East railway network, and RingGo, a mobile-phone-enabled parking service currently offered in public car parks in the United Kingdom.

There is a need for technology that allows consumers to utilize their mobile devices, and in particular, their mobile telephones, to scan and validate purchases and perform secure (e.g., encrypted) payment processing, without the need to interact with specialized retailer equipment and retailer personnel, and which eliminates the need for consumers to provide confidential financial information to the retailer. The present invention meets this need, among others.

### SUMMARY OF THE INVENTION

The present invention incorporates scanning technology and secure payment technology into the operating system (OS) of a mobile device such as a smartphone. In a preferred embodiment, the scanning technology comprises RFID interrogation capability. This enables smartphone users to validate transactions during a shopping session at a retail location (i.e., scan items as they are added to their shopping cart) and streamline the payment process by electronically transmitting their credit/debit card information directly to their financial institution to authorize payment to finish the transaction, all while within the retail location.

### BRIEF DESCRIPTION OF THE DRAWINGS

FIG. 1 illustrates a typical environment in which the present invention can be utilized;

FIG. 2 illustrates generally the inclusion of scanning and payment modules into an operating system of a mobile device in accordance with the present invention; and

FIG. 3 is a flowchart illustrating steps preformed in accordance the present invention to enable the seamless scanning and purchase of items using a mobile device configured in accordance with the present invention.

### DETAILED DESCRIPTION OF THE PREFERRED EMBODIMENTS

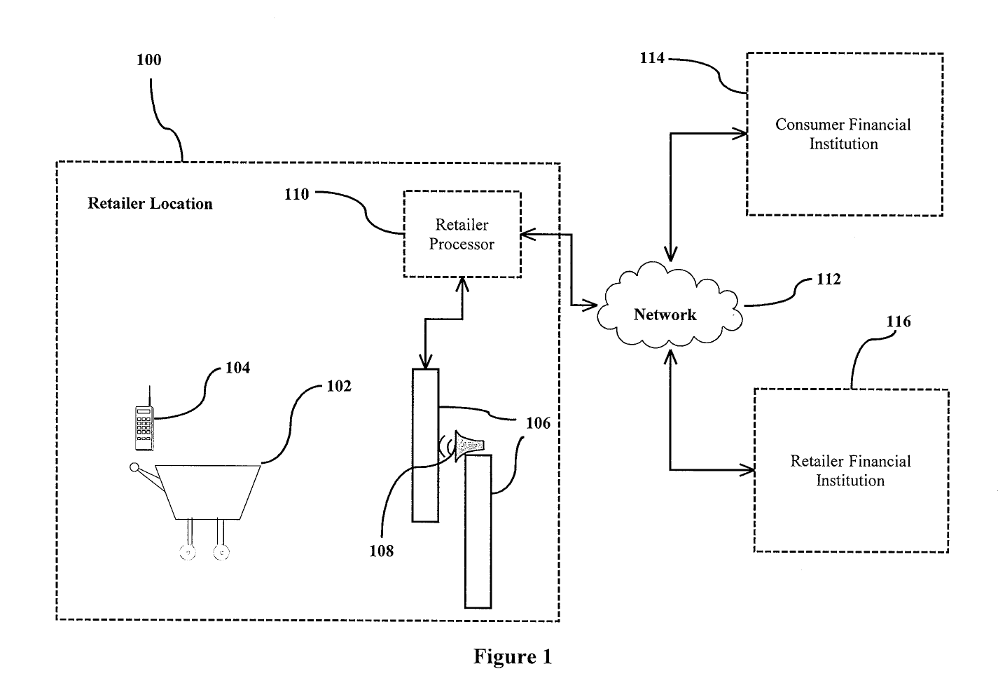

FIGS. 1 through 3 illustrate the concept and structure of the present invention. Referring to FIG. 1, a retail location 100 is illustrated. In this example, the seller (also referred to herein as “retailer”) location is a grocery store in which a consumer will traverse the store with a shopping cart 102 selecting items for purchase in a well known manner. The items available for purchase in the store must be tagged with RFID tags that provide unique product information pertaining to the item. In some cases, the items may already have RFID tags on them for inventory or shoplifting prevention. Systems such as this use an RFID reader at the store exit and the RFID tag is either removed upon purchase or is electronically modified upon purchase (e.g., the final digits of the ID number of the tag can be changed from a 0 to a 1, with a last digit of “1” indicating a purchased item). It is understood that the present invention is not limited to a grocery store and can be any location where a consumer will be selecting items for purchase or consumption.

In the RFID tag embodiment, each item must have an RFID tag on it. Each tag could have a unique RFID number (e.g., one box of cereal A will have a different RFID number than another box of cereal A) or unique RFID numbers could be assigned by product type (e.g., all boxes of cereal A will have the same number).

The retail location 100 in this example includes security sensors 106 and a security alarm 108 coupled to a retailer processor 1 10. Typically these sensors will be installed at exits of the store so that if an item is being carried out that has not been purchased, the sensors 106 will sense this and security alarm 108 will be sounded to alert store personnel of a possible theft event. As will be described further below, the retailer processor 1 1 0 performs, among other functions, a processing of information between security sensors 106 and entities external to the retail location, such as a consumer financial institution 1 14 or a retailer financial institution 1 16. As can be seen in FIG. 1, the connectivity between the retailer processor 110 and the external entities can be effected via a network connection 112.

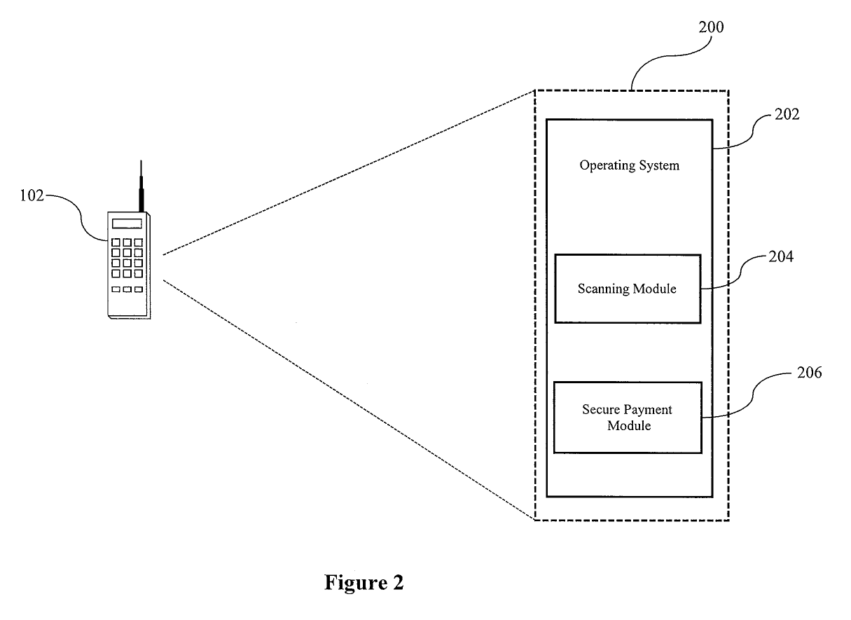

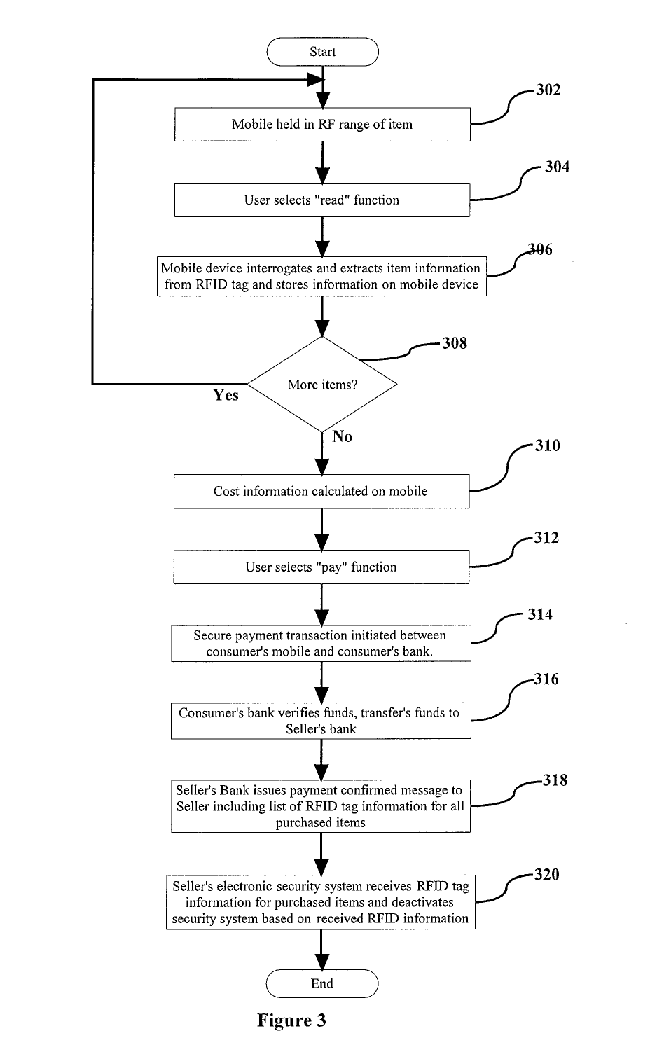

In accordance with the present invention, a consumer possessing a mobile device such as mobile telephone 104 uses the mobile device to identify items to be purchased and to make payment for the purchases. The mobile device, such as mobile telephone 104, can communicate using known communication techniques (SMS messaging, Internet connection, normal telephone connection, etc.) to communicate with external elements such as a consumer's financial institution 114. As described in more detail below with respect to FIGS. 2 and 3, a mobile device configured in accordance with the present invention can carry out these multiple tasks without the need to interact with any personnel at the retail location 100 and without the need for standard point-of-sale (POS) terminals that are found in conventional retail locations.

Referring to FIG. 2, the mobile telephone 104 stores software 200 that configures the device for the above-described tasks. In a preferred embodiment the software modules that enable the present invention are integrated into the operating system (OS) of the mobile telephone 104, although independent modules could instead be utilized if desired. Specifically, operating system 202 of the mobile telephone 104 is configured to include a scanning module 204 and a secure payment module 206. If implemented as a standalone application outside of the OS, supporting modules would be provided at each supporting location, e.g., at a consumer's financial organization, at the seller's financial organization, at the seller's location, etc.

The scanning module, in a preferred embodiment, can be an RFID reader such as the RFID reader kit manufactured and sold by Nokia. Any RFID reader system and software capable of operating on a mobile telephone will function for the purpose of RFID reading required for the present invention. It is understood that such RFID reader systems may include additional hardware coupled to the mobile telephone, or may be implemented in software that uses the existing communication capabilities of the mobile telephone hardware to perform the RFID scanning functions enabled by the added software. It is understood that if desired, alternate scanning techniques (e.g., barcode scanning, Bluetooth, infrared, etc.) can be utilized and still fall within the scope of the present invention.

Secure payment module 206 can comprise any payment method which provides the ability to conduct secure payment transactions via a mobile telephone. Examples include mobile Suica, a service for Osaifu Keitai Mobile Phones of Japan and the RingGo mobile phone parking service offered in the United Kingdom. Each of these systems includes the capability to securely conduct payment transactions via a mobile telephone, and these systems or systems that function similarly can be used to perform the function of the secure payment module 206. Credit cards, debit cards, direct bank deductions, and other payment methods may be used. For example, a consumer could pre-register a credit/debit card details with the payment module on the mobile device, and then the transaction could be effected via the credit/debit card.

FIG. 3 is a flowchart illustrating the steps performed by a mobile phone 104 configured in accordance with the present invention. By configuring the mobile device in the manner described and illustrated by the flowchart, a consumer at a retail store can seamlessly gather, scan, and pay for their desired products without the need to interact with employees of the retail store and without the retail store needing to have any special scanning or payment equipment. At step 302, a mobile device is held within RF range of an item to be purchased. In the preferred embodiment, in which each item in the store is tagged with an RFID tag and in which the mobile telephone scanning module is an RFID scanning module, the RF range of the mobile device should be limited so that a consumer can scan the particular item with the mobile telephone without accidentally scanning other items which may be in close proximity, e.g., on a shelf, but which the consumer is not intending to purchase. In a preferred embodiment, the RF range of the mobile telephone can be 0.5-1.0 cm, although it is understood that this distance can be varied in accordance with the needs of the designer.

At step 304, with the mobile device being held in RF range of the item, the user selects a read function, which triggers the mobile device to scan the item that is it in close proximity to. It is understood that the reading function can be automatic (i.e., without requiring the user to select a read function for each item). At step 306, upon selection of the read function, the mobile device interrogates and extracts product information from the RFID tag and stores the information on the mobile device. This process then completes the scanning of the information pertaining to one item onto the mobile device.

At step 3 08, a determination is made as to whether or not there are more items to scan. If there are more items to scan, the process reverts back to step 302, and the scanning process continues for the next item. This process is repeated until there are no more items to scan. At step 310, a total cost information for the items that have been scanned is calculated on the mobile device. This gives a total amount and, in a preferred embodiment, includes a calculation of any taxes to be charged. Further, although not shown in FIG. 3, if the user has RFID coupons to be scanned, they can be scanned before the calculation step or after the calculation step, at which point the appropriate deductions can be made to the total.

At step 312, the user selects a pay function. This can be performed simply by pressing a key on the mobile device to select this function. At step 314, a secure payment transaction is initiated between the consumer's mobile device and the consumer's bank or financial institution 114. At step 316, the consumer's bank verifies that funds are available, verifies that the transaction is being performed by an authorized user (using well known security techniques), and then transfers the appropriate funds to the retailer's financial institution 116. At step 318, the retailer's financial institution 116 issues a “payment confirmed message” to the retailer processor 110 and includes in this “payment confirmed message” a list of RFID tag information for each purchased item.

At step 320, the retailer processor receives the payment confirmed message, including the RFID tag information for the purchased items, and deactivates the security sensors 206 for the identified items, so that the consumer may pass the security sensors without setting off security alarm 108.

The present invention, as described above and illustrated in the drawings, moves the entire transaction process essentially to the mobile device of the consumer and therefore eliminates the need for the consumer to interact with store employees, specialized scanning devices of the store, and allows the consumer to avoid the long queues that may occur at a standard shopping checkout line.

Numerous variations of the present invention will be evident to a designer. For example, a consumer at a restaurant or bar can scan consumed items from a “menu” of items such that a tally is kept on the mobile device, and then payment can be effected as described above. Similarly, consumable items, e.g., a bottle of beer, can have RFID tags, bar codes, and the like affixed thereon and can be scanned as they are purchased.

The benefits of the present invention are numerous. For example, using the present invention, a retailer does not need to have exclusive equipment for scanning and for payment, or can reduce the number of these needed (there will still be a need to accommodate consumers who do not have a mobile telephone capable of performing the above-described functions). Time can be saved because the consumer handles the entire transaction as they shop, and the consumer does not need to carry credit cards, debit cards, or cash.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. A method of enabling transaction validation and payment processing for a sales transaction using a mobile device, wherein the sales transaction includes the purchase of one or more items by a consumer from a seller, each of which are configured to be scannable, comprising:
configuring the mobile device to perform a scanning function to interrogate said scannable items and extract therefrom item information;
configuring the mobile device to perform a payment processing function based on said extracted item information, said processing function including:
sending a secure communication to a financial institution associated with the consumer, said secure communication transmitting financial information pertaining to the sales transaction, instructing said financial institution to forward payment for said transaction to a financial institution associated with the seller, and instructing the seller institution to forward to said seller sale-validation information pertaining to each scannable item scanned by said mobile device.

2. The method of claim 1, wherein said mobile device is configured to perform an RFID scanning function, and wherein said items are configured to be scannable by tagging them with RFID tags.

3. The method of claim 1, wherein said mobile device is configured to perform the payment processing function using SMS messaging.

4. The method of claim 3, wherein said SMS messaging is encrypted SMS messaging.

5. The method of claim 1, wherein said mobile device comprises a mobile telephone.

6. A system of enabling transaction validation and payment processing for a sales transaction using a mobile device, wherein the sales transaction includes the purchase of one or more items by a consumer from a seller, each of which are configured to be scannable, comprising:
means for configuring the mobile device to perform a scanning function to interrogate said scannable items and extract therefrom item information;
means for configuring the mobile device to perform a payment processing function based on said extracted item information, said processing function including:
means for sending a secure communication to a financial institution associated with the consumer, said secure communication transmitting financial information pertaining to the sales transaction, instructing said financial institution to forward payment for said transaction to a financial institution associated with the seller, and instructing the seller institution to forward to said seller sale-validation information pertaining to each scannable item scanned by said mobile device.

7. The system of claim 6, wherein said mobile device is configured to perform an RFID scanning function, and wherein said items are configured to be scannable by tagging them with RFID tags.

8. The system of claim 6, wherein said mobile device is configured to perform the payment processing function using SMS messaging.

9. The system of claim 8, wherein said SMS messaging is encrypted SMS messaging.

10. The system of claim 6, wherein said mobile device comprises a mobile telephone.

11. A computer program product for enabling transaction validation and payment processing for a sales transaction using a mobile device, wherein the sales transaction includes the purchase of one or more items by a consumer from a seller, each of which are configured to be scannable, the computer program product comprising a computer-readable storage medium having computer-readable program code embodied in the medium, the computer-readable program code comprising:
computer-readable program code that configures the mobile device to perform a scanning function to interrogate said scannable items and extract therefrom item information;
computer-readable program code that configures the mobile device to perform a payment processing function based on said extracted item information, said processing function including:
computer-readable program code that sends a secure communication to a financial institution associated with the consumer, said secure communication transmitting financial information pertaining to the sales transaction, instructing said financial institution to forward payment for said transaction to a financial institution associated with the seller, and instructing the seller institution to forward to said seller sale-validation information pertaining to each scannable item scanned by said mobile device.

12. The computer program product of claim 11, wherein said mobile device is configured to perform an RFID scanning function, and wherein said items are configured to be scannable by tagging them with RFID tags.

13. The computer program product of claim 11, wherein said mobile device is configured to perform the payment processing function using SMS messaging.

14. The computer program product of claim 13, wherein said SMS messaging is encrypted SMS messaging.

15. The computer program product of claim 11, wherein said mobile device comprises a mobile telephone.

16. A method of performing a complete sales transaction of RFID-tagged items from a seller's location, comprising:
configuring a mobile telephone to perform RFID scanning and perform secure payment transactions directly with financial institutions;
having a consumer scan RFID-tagged items to be purchased using said mobile telephone; and
having the consumer perform a secure payment transaction using said mobile telephone.

17. An improved operating system (OS) for a mobile telephone, comprising:
an RFID scanning module enabling said mobile telephone to scan items bearing RFID tags and store information extracted form said RFID tags;
a secure payment-transaction module enabling said mobile telephone to communicate directly with one or more financial institutions to effect payment for said scanned items, and to identify said scanned items as being purchased items once payment for said scanned items has been effected.
